(19) United States
(12) Patent Application Publication
(10) Pub. No.: US 2005/0139272 A1
(43) Pub. Date: Jun. 30, 2005

(54) Rotary air distributor

(76) Inventor: Lyman L. Thornton, Waterford, MI (US)

Correspondence Address: L.C. Begin & Associates, PLLC, 510 Highland Avenue, PMB 403, Milford, MI, 48381, US

(21) Appl. No.: 10/974,090

(22) Filed: Oct. 27, 2004

Related U.S. Application Data
(60) Provisional application No. 60/515,133, filed on Oct. 28, 2003.

(51) Int. Cl. F16K 11/072

(52) U.S. Cl. 137/625.46

(57) ABSTRACT

A rotary valve (10) and valve assembly for use in a regenerative oxidizer (12). The rotary valve (10) has a central shaft (32) with a longitudinal axis (L), and a plurality of gas flow plenums (60, 64, 68) extending along the shaft (32), at least a portion of each plenum extending around a portion of the shaft (32) in a spiral configuration. The rotary valve (10) is incorporated into a rotary valve assembly comprising an inner housing (72) enclosing the valve (10). The inner housing (72) is fixed with respect to the valve (10) so as to rotate in correspondence with the valve (10). A plurality of windows (80, 84, 86) is formed along the inner housing (72), at least one window of the plurality of windows (80, 84, 86) being in fluid communication with a corresponding one of the valve plenums (60, 64, 68). An outer housing (16) encloses the inner housing (72) and has a plurality of flow apertures (17a, 17b, 17c) formed therealong, each of the fluid flow apertures (17a, 17b) being in fluid communication with a corresponding one of a pair of regenerative chambers (12a, 12b) in the regenerative oxidizer (12). The inner housing (72) is rotatable with respect to the outer housing (16) to bring an inner housing window (80, 84, 86) into alignment with an outer housing fluid flow aperture (17a, 17b, 17c), thereby bringing the inner housing window (80, 84, 86) into fluid communication with the outer housing aperture (17a, 17b, 17c) and correspondingly enabling fluid communication between a plenum that is in fluid communication with the window, and the regenerative chamber that is in fluid communication with the outer housing flow aperture.

### CROSS-REFERNCE TO RELATED APPLICATION

This application is entitled to and claims the benefit of Provisional Patent Application Ser. No. 60/515,133, filed on Oct. 28, 2003.

### BACKGROUND OF THE INVENTION

The present invention relates generally to oxidizer systems for the abatement of process emissions and more particularly, to a rotary valve assembly for controlling flow of contaminated process emissions to and from chambers of a regenerative oxidizer.

Process emissions often contain combustible contaminants that, if released to the atmosphere, have the potential of polluting the environment. However, the amount of combustible material contained in such emissions is generally below several thousand ppm and, accordingly, will not ignite or propagate a flame at ambient temperature.

Oxidizers increase the temperature of such process emissions to a level above the ignition temperature of the combustible contaminants by the use of heat derived from a supplemental energy source, therefore allowing for oxidation of the emissions. Regenerative oxidizers recover heat remaining in the cleansed exhaust gas to increase the temperature of emissions entering the oxidizer thereby minimizing the amount of supplemental energy required to raise the emission to its ignition temperature.

Known regenerative oxidizers typically comprise a plurality of conventional regenerator beds that communicate with a combustion chamber. The regenerator beds contain conventional ceramic heat exchange elements. Admission of emissions into each regenerator bed is controlled by a valve network. During operation of a regenerative oxidizer that contains, for example, three regenerator beds, emissions pass through a first regenerator bed to pick up heat therefrom, thence to the combustion chamber for oxidation. Following oxidation to CO₂ and H₂O, the cleansed air then passes through a second regenerator bed, which is operating in the regenerative, or heat receptive, mode for discharge to atmosphere or to a purified air duct which conducts purified air to a third regenerator bed to purge the bed of contaminants. Thus, each regenerator bed performs three modes of operation: a feed mode, a heat receptive mode, and a purge mode.

FIG. 1 shows an example of a prior art regenerative oxidizer. The oxidizer 510 utilizes a plurality of valves 512 to control the flow of contaminated emissions and cleansed air to and from the oxidizer 510, respectively. The oxidizer 510 comprises a plurality of conventional regenerator beds 514, 516 and 518 that communicate with a combustion chamber 520. Fuel, for example natural gas, is supplied to the combustion chamber 520 from a fuel control and burner 521. Emissions are conducted to the oxidizer 510 from an inflow duct 522. Cleansed air is conducted away from the oxidizer 510 by an outflow duct 524 that is in fluid communication relationship with an exhaust blower 526. Exhaust air may be vented to atmosphere or conducted through a conduit 528 to ducts to selectively purge the regenerator beds 514, 516 or 518. After passing the selectively opened valves 512, the contaminated fluids are ducted to the regenerative beds 514, 516 and 518 by ducts 530, 532 and 534, respectively.

However, a problem with the arrangement described above is that the use of three separate valve assemblies to control emissions flow to and from the three regenerative beds increases the production and maintenance costs of the oxidizer system and complicates assembly and control of the system.

### SUMMARY OF THE INVENTION

The present invention includes a rotary valve having a central shaft with a longitudinal axis, and a plurality of gas flow plenums extending along the shaft, at least a portion of each plenum extending around a portion of the shaft in a spiral configuration. The rotary valve is incorporated into a rotary valve assembly comprising an inner housing enclosing the valve, the inner housing being fixed with respect to the valve so as to rotate in correspondence with the valve.

A plurality of windows is formed along the inner housing, at least one window of the plurality of windows being in fluid communication with a corresponding one of the valve plenums.

An outer housing encloses the inner housing and has at least two fluid flow apertures formed therealong, each of the fluid flow apertures being in fluid communication with a corresponding one of a pair of regenerative chambers in a regenerative oxidizer.

The inner housing is rotatable with respect to the outer housing to bring an inner housing window into alignment with an outer housing fluid flow aperture, thereby bringing the inner housing window into fluid communication with the outer housing aperture and correspondingly enabling fluid communication between the plenum that is in fluid communication with the window, and the regenerative chamber that is in fluid communication with the outer housing flow aperture.

The single rotary valve described herein is designed to replace the multiple valves currently used in regenerative oxidizers such as the prior art device previously described. By reducing the number of valves needed for control of gas flow to and from the regenerative chambers, the production and maintenance costs of the oxidizer system and the complexity of the flow control system are reduced.

### BRIEF DESCRIPTION OF THE DRAWINGS

In the drawings illustrating embodiments of the present invention:

FIG. 1 is a cross-sectional side view showing a regenerative oxidizer incorporating a rotary valve and valve assembly in accordance with the present invention;

FIG. 2 is a cross-sectional side view showing a the rotary valve and valve assembly of FIG. 1;

FIG. 3 is a cross-sectional end view of the valve assembly of FIG. 2 taken along line 3-3 of FIG. 2;

FIG. 4 is a cross-sectional end view of the valve assembly of FIG. 2 taken along line 44 of FIG. 2;

FIG. 5 is a cross-sectional end view of the valve assembly of FIG. 2 taken along line 5-5 of FIG. 2;

FIG. 6 is an exploded perspective view of the valve assembly of FIG. 2; and

FIG. 7 is a perspective view of an example of a prior art regenerative oxidizer;

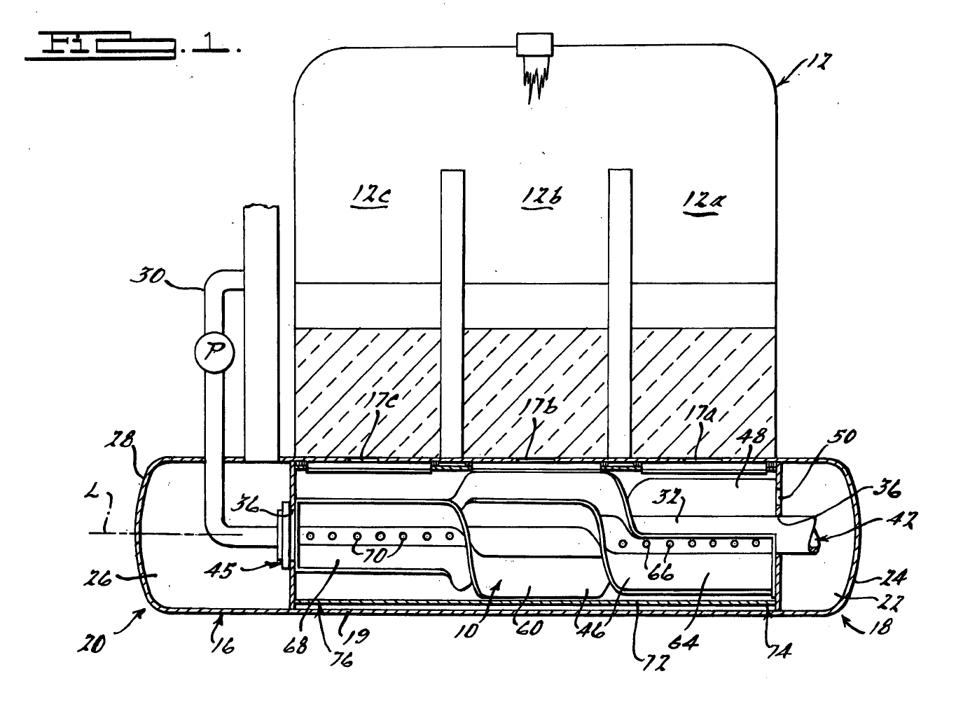

### DETAILED DESCRIPTION

Referring to the figures, a rotary oxidizer valve 10 is shown as associated with an exemplary regenerative oxidizer 12. As known in the art, depending on the purity required, two or more chambers 12a-12b are included in the regenerative oxidizer 12. Exemplary regenerative oxidizers include those described in the U.S. Pat. Nos. 5,612,005; 5,643,539; 5,967,771; 5,000,422, incorporated herein by reference.

The rotary oxidizer valve 10 is contained within a fixed valve housing 16. Housing 16 has a first end 18 and a second end 20. In a preferred embodiment, a plurality of gas apertures or slots 17a-c are evenly spaced across the length of an outer wall 19 of the housing 16, thereby providing fluid flow to and from the interior of housing 16 and the interior of oxidizer 12. A plurality of regenerative chambers 12a 12c extends from the oxidizer 12, whereby each chamber is ducted to the outer wall 19 to provide fluid communication with gas apertures 17a-17c, respectively. A first or inlet end 18 of the housing 16 communicates with an inlet source of gas or air to be purified. A second or outlet end 20 of the housing 16 communicates with an oxidizer exhaust stream and serves to exhaust cleansed air to the environment. An inlet plenum 22 is defined by a first cap 24 at the first end 18 and receives an inlet gas stream to be fed to the oxidizer 12. The first cap 24 is sealed to the stationary housing 16 except where directed to the gas inlet stream, thereby preventing any release of inlet gas and ensuring a steady flow of gas to the valve 10.

An outlet plenum 26 is defined by a second cap 28 and fluidly communicates with an exhaust stream from the oxidizer 12, thereby ducting the exhaust stream to the environment. The second cap 28 is also sealed to the fixed housing 16. If desired, a purge conduit 30 fluidly communicates with the outlet plenum 26 and, as explained below, is routed back within the valve 10 thereby providing a source of purge air to the valve 10.

A hollow shaft 32 longitudinally extends through the valve 10 and is journaled on bearings 34 thereby facilitating rotation of the valve 10 within the housing 16. The shaft 32 extends through the first and second end caps 24 and 28, respectively; through a corresponding apertures 36 in end caps 24.

An actuator 40 (not shown) drives the shaft 32 and may be electrically, hydraulically, or pneumatically powered. The actuator 40 incorporates intermittent gearing as exemplified by a Geneva Wheel, for example. Accordingly, the valve 10 may be indexed over a predetermined time wherein the valve 10 rotates over a predetermined arcuate length (e.g. 60 degrees) each time the valve 10 is indexed. It should be emphasized, however, that the actuator employed will be designed to accommodate the desired cycle time, six to twelve minutes for example. An exemplary cycle generally consists of six periods, each about one to two minutes, wherein a first period is a first purge, second and third periods are outlets, a fourth period is a second purge, and fifth and sixth periods are inlets to the regenerative oxidizer 12. Other known or suitable actuators may be employed and are also contemplated as useful in the present invention.

An annular channel 42 is defined by an inner wall 44 of the shaft 32 and receives a purge stream from the purge conduit 30. The purge conduit 30 is fixed to secondary bearings 45 attached to a corresponding end of the shaft 32, thereby facilitating independent rotary movement of the shaft 32 while conduit 30 remains fixed in place.

The valve 10 has a longitudinal axis L and contains a plurality of valve helical plenums 46 each defining a substantially helical or spiral shape. A valve feed plenum 48 fluidly communicates with the inlet plenum 22 through at least one aperture 50 defined within the inlet plenum 22. As the valve 10 is indexed, inlet flow to the oxidizer is thereby cyclically routed through the plenum 48 to respective ones of chambers 12a-12c within the oxidizer 10.

A valve exhaust plenum 60 is symmetrically oriented opposite the valve feed plenum 48 and fluidly communicates with the outlet plenum 26 through at least one outlet aperture (not shown) defined within the outlet plenum 26. As the valve 10 is indexed, exhaust flow from an associated regenerative chamber is cyclically routed through the exhaust plenum 60 and through the outlet plenum 26. A first valve purge plenum 64 fluidly communicates with the annular channel 42 thereby providing a source of purge air to the oxidizer 12. A first plurality of purge apertures 66 are radially formed in and through the shaft 32 and are contained within the first purge plenum 64 thereby facilitating a relatively high pressure fluid flow from the shaft 32 to the first purge plenum 64.

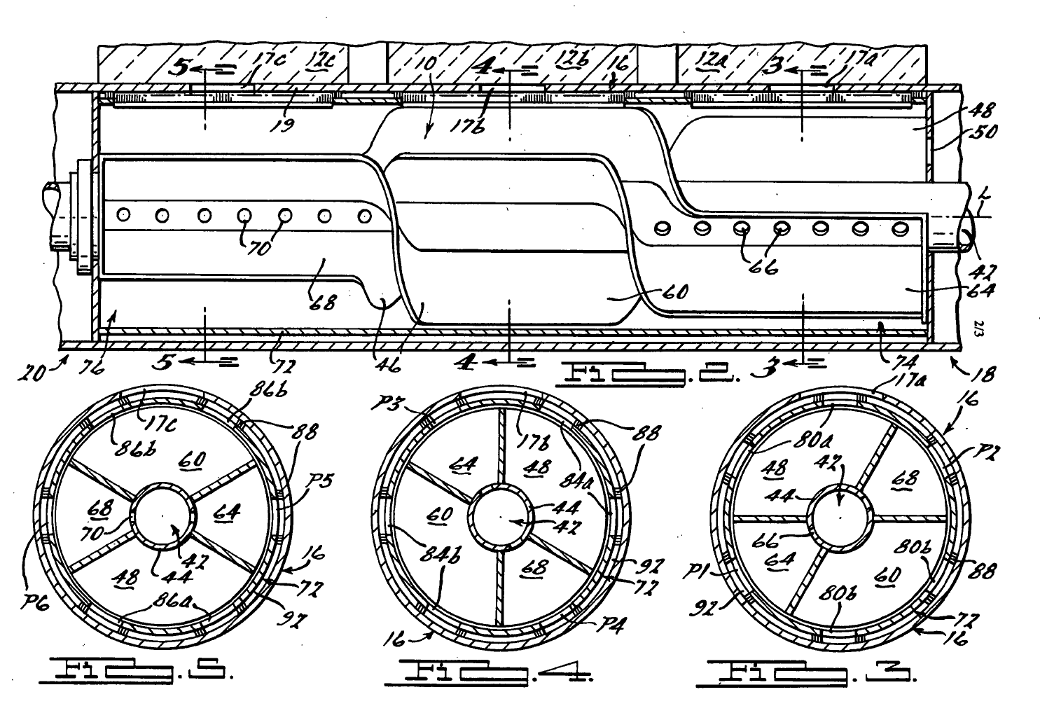

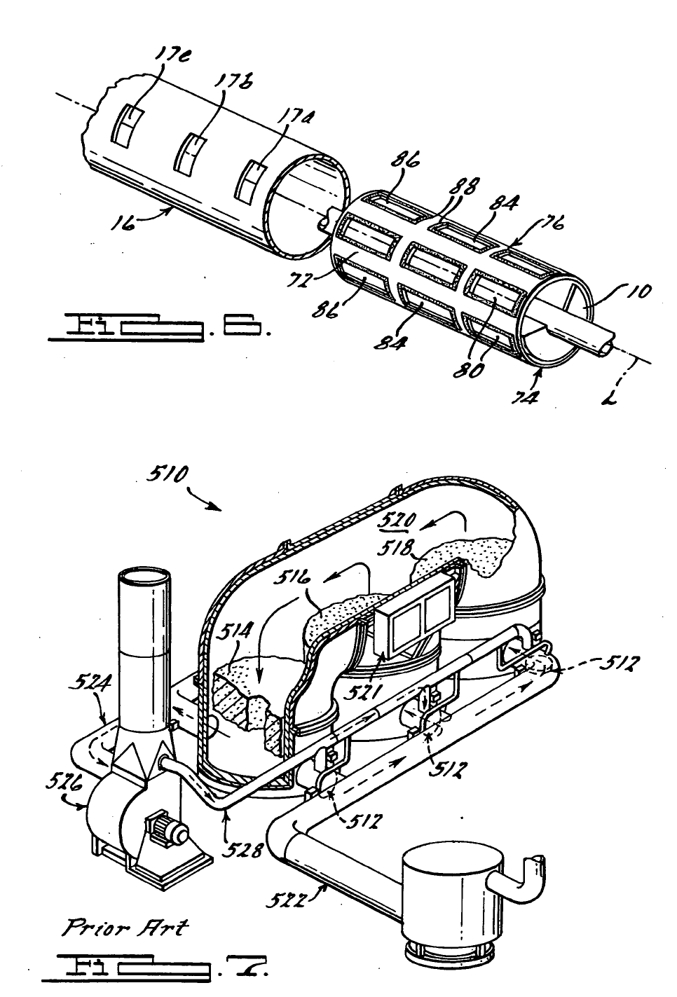

FIGS. 3-5 show cross-sectional views of the valve assembly taken at various points along the length of valve 10. These views show the alignments between the various plenums 60, 64, 68; the inner housing windows 80, 84, 86; and the outer housing flow apertures 17a-17c. Referring to FIGS. 3-5, the first purge plenum 64 is formed between the valve feed plenum 48 and the valve exhaust plenum 60 thereby providing an air seal between the valve inlet and valve exhaust plenums and comprises about half of the volume of the feed and exhaust plenums. As such, when the valve 10 is indexed, the purge plenum 64 comprises about half the arcuate length of the feed and exhaust plenums. Accordingly, the purge function established by rotation of the valve 10 is about half of the time dedicated to either the feed or exhaust plenums. A second valve purge plenum 68 fluidly communicates with the annular channel 42 thereby providing a source of purge air to the oxidizer 12. A second plurality of purge apertures 70 are radially formed in and through the shaft 32 and are contained within the second purge plenum 68 thereby facilitating a relatively high pressure fluid flow from the shaft 32 to the second purge plenum 68. As with the first purge plenum 64, the second purge plenum 68 is formed between the valve feed plenum 48 and the valve exhaust plenum 60 (and opposite the first purge plenum 64), thereby providing an air seal between the valve inlet and valve exhaust plenums and comprises about half of the volume of the feed and exhaust plenums. As such, when the valve 10 is indexed, the purge plenum 68 also comprises about half the arcuate length of the feed and exhaust plenums. Accordingly, the purge function established by rotation of the valve 10 is about half of the time dedicated to either the feed or exhaust plenums.

In further accordance with the present invention, a second housing 72 is contained within the first housing 16 and encapsulates the rotary valve 10, thereby facilitating fluid flow from the rotary valve 10 to the multi chamber regenerative chamber 12. The housing 72 contains a first end 74 and a second end 76 corresponding to first and second ends 18 and 20 of housing 16. A plurality of windows or gas flow apertures 78 are formed along the periphery of the housing 72.

A first plurality of windows 80 are circumferentially aligned proximate to first end 74 along a plane extending orthogonal to longitudinal axis L. Each window in the plurality of windows 80 is located within a respective plenum.

Accordingly, at least one of a first window 80a is formed within the feed plenum 48 and thereby communicates inlet air to a first regenerative chamber 12a, as the valve 10 is rotated to align window 80a and regenerative chamber 12a. At least one of a second window 80b is circumferentially aligned with window 80a and is formed within the outlet plenum 60, thereby providing fluid flow from regenerative chamber 12a when it functions to exhaust purified air from the regenerative oxidizer 12. If desired, one or more additional windows P1, P2 may be added over one or both purge sections to provide a purge stream through regenerative chamber 12a as the respective purge window is aligned with the chamber 12a.

A second plurality of windows 84 are circumferentially aligned intermediate of first end 74 and second end 76 along a plane extending orthogonal to longitudinal axis L. Each window in the plurality of windows 84 is also located within a respective plenum. Accordingly, a third window 84a is formed within the inlet plenum 48 and thereby communicates inlet air to a second regenerative chamber 12b, as the valve 10 is rotated to align window 84a and regenerative chamber 12b. A fourth window 84b is circumferentially aligned with window 84a and is formed within the outlet plenum 60, thereby providing fluid flow from regenerative chamber 12b when it functions to exhaust purified air from the regenerative oxidizer 12. If desired, one or more additional windows P3, P4 may be added over one or both purge sections to provide a purge stream through regenerative chamber 12b as the respective purge window is aligned with the chamber 12b.

A third plurality of windows 86 are circumferentially aligned proximate to the second end 76 along a plane extending orthogonal to longitudinal axis L. Each window in the plurality of windows 86 is also located within a respective plenum. Accordingly, a fifth window 86a is formed within the inlet plenum 48 and thereby communicates inlet air to a third regenerative chamber 12c, as the valve 10 is rotated to align window 86a and regenerative chamber 12b. A sixth window 86b is circumferentially aligned with window 86a and is formed within the outlet plenum 60, thereby providing fluid flow from regenerative chamber 12c when it functions to exhaust purified air from the regenerative oxidizer 12. If desired, one or more additional windows P5, P6 may be added over one or both purge sections to provide a purge stream through regenerative chamber 12c as the respective purge window is aligned with the chamber 12c. Additional pluralities of circumferentially aligned windows may be added as the size of the regenerative oxidizer 12 is increased. For example, given a five chamber regenerative chamber, a rotary valve 10 would include five pluralities of circumferentially aligned windows thereby providing intermittent or continuous fluid flow to each regenerative chamber.

In yet another aspect of the present invention, a plurality of wire brush seals 88 is employed, wherein each wire brush seal 88 is fixed about the periphery of each window 80, 84, 86 on an outer surface 90 of the housing 72. An annular gap or clearance 92 exists between the outer wall 90 of housing 72 and an inner wall 15 of housing 16. The wire brush seals 88 radially extend from the outer wall 90 to the inner wall 15, thereby defining an annular and arcuate sweep against the inner wall 15 upon rotation of the housing 72. When windows 78 are not aligned with gas apertures 17a 17c, the wire brush seals 88 inhibit the flow from each respective window within the housing 16 and within the gap 92.

In operation, as the valve 10 and the housing 72 are periodically rotated by the actuator, the various air/gas streams to and from the regenerative oxidizer 12 are alternated from chamber to chamber. For example, if at one point in time chamber 12a functioned as an inlet chamber, and chamber 12b functioned as an outlet chamber, then chamber 12c would either be inactive or functioning as a purge chamber depending on design choice. Upon valve 10 rotation, chamber 12c might then function as the outlet, chamber 12a as a purge chamber, and chamber 12b as an inlet.

Accordingly, in a first embodiment, the windows 80, 84, 86 are formed within the outer wall 90 to facilitate an ordered function of each chamber whereby each chamber functions as an inlet, two purges, and an outlet in a six period cycle of operation as the valve 10 is rotatably indexed. Stated another way, while one chamber functions as an inlet, the other chambers will preferably reflect other functions such as a gas outlet or purge. As such, in any given moment, each chamber will preferably have a unique function or will be inactive; no two chambers will reflect the same function at the same time. Of course, as the size of the regenerative oxidizer increases, it may be desirable to design the windows 80, 84, 86 so that two chambers, rather than just one chamber, functions as a gas inlet rather than just one, for example. In that case, two windows 80, 84, 86 aligned with chambers 12a and 12b, for example, would fluidly communicate with the inlet plenum 22 thereby providing a greater inlet flow to the oxidizer 12. One of ordinary skill in the art will appreciate the myriad of other design permutations depending on the oxidizer size and requirements.

It will be understood that the foregoing description of an embodiment of the present invention is for illustrative purposes only. As such, the various structural and operational features herein disclosed are susceptible to a number of modifications commensurate with the abilities of one of ordinary skill in the art, none of which departs from the scope of the present invention as described above and as defined in the appended claims.

1. A rotary valve comprising:
a central shaft having a longitudinal axis; and
a plurality of gas flow plenums extending along the shaft, at least a portion of each plenum extending around a portion of the shaft in a spiral configuration.

2. The valve of claim 1 wherein at least a portion of each plenum extends substantially parallel with the longitudinal axis.

3. The valve of claim 1 wherein the shaft has a wall defining a fluid flow channel extending along the shaft.

4. The valve of claim 3 further comprising at least one aperture formed in the wall of the shaft to enable fluid communication between the shaft fluid flow channel and at least one of the fluid flow plenums.

5. The valve of claim 1 wherein a portion of a first plenum and a portion of a second plenum are aligned longitudinally along the valve.

6. The valve of claim 1 wherein a portion of a first plenum and a portion of a second plenum are aligned along a plane extending orthogonal to the shaft longitudinal axis.

7. The valve of claim 1 wherein a first plenum of the plurality of plenums has a first volume and a second plenum of the plurality of plenums has a second volume substantially equal to the first volume.

8. The valve of claim 1 wherein a first plenum of the plurality of plenums has a first volume, a second plenum of the plurality of plenums has a second volume, a third plenum of the plurality of plenums has a third volume, and wherein the third volume is different from the first volume and the second volume.

9. The valve of claim 8 wherein the third volume is approximately half of either of the first or second volumes.

10. The valve of claim 8 wherein a fourth plenum of the plurality of plenums has a fourth volume, and wherein the fourth volume is substantially equal to the third volume.

11. The valve of claim 1 wherein a first plenum of the plurality of plenums and a second plenum of the plurality of plenums extend along diametrically opposite sides of the longitudinal axis.

12. The valve of claim 11 wherein the first plenum has a first volume, the second plenum has a second volume, and the second volume is substantially equal to the first volume.

13. A rotary valve assembly comprising:
a rotary valve including a central shaft having a longitudinal axis, a plurality of gas flow plenums extending along the shaft;
an inner housing enclosing the valve, the inner housing being fixed with respect to the valve so as to rotate in correspondence with the valve;
a plurality of windows formed along the inner housing, at least one window of the plurality of windows being in fluid communication with a corresponding one of the valve plenums;
an outer housing enclosing the inner housing; and
a plurality of gas flow apertures formed along the outer housing, the inner housing being rotatable with respect to the outer housing such that each of the inner housing windows is rotatably alignable with at least one of the outer housing gas flow apertures to enable fluid communication between an outer housing gas flow aperture and a corresponding plenum that is in fluid communication with an inner housing window.

14. The valve assembly of claim 13 wherein at least a portion of each plenum extends around a portion of the shaft in a spiral configuration.

15. The valve assembly of claim 13 wherein the inner housing is rotatable with respect to the outer housing such that each of the inner housing windows is rotatably alignable with at least one of the outer housing gas flow apertures along a plane extending orthogonal to the shaft longitudinal axis.

16. The valve assembly of claim 13 wherein the outer housing defines a gas inlet plenum in fluid communication with at least one of the valve plenums, for conveying fluid to the at least one of the valve plenums.

17. The valve assembly of claim 13 wherein the outer housing defines a gas outlet plenum in fluid communication with at least one of the valve plenums, for receiving fluid from the at least one of the valve plenums.

18. The valve assembly of claim 13 wherein the outer housing has an aperture formed therein for receiving the valve shaft therethrough.

19. The valve assembly of claim 13 wherein the shaft has a wall defining a fluid flow channel extending along the shaft.

20. The valve of claim 19 further comprising at least one aperture formed in the wall of the shaft to enable fluid communication between the shaft fluid flow channel and at least one of the fluid flow plenums.

21. The valve assembly of claim 22 wherein the outer housing has an aperture formed therein through which a conduit extends, the conduit being in fluid communication with the fluid flow channel extending along the valve shaft.

22. The valve assembly of claim 13 wherein the outer housing gas flow apertures are aligned along a line extending parallel to the shaft longitudinal axis.

23. The valve assembly of claim 13 wherein a space is formed between the inner housing and the outer housing, and a seal member extends along a perimeter of each of the inner housing windows, and wherein the seal member spans the space between the inner housing and the outer housing to provide a seal inhibiting fluid flow between the inner housing windows and the space.

24. The valve assembly of claim 23 wherein the seal member comprises a wire brush seal.

25. A regenerative oxidizer system comprising:
at least two regenerative chambers; and
a rotary valve assembly for directing fluid flow to and from each of the chambers, the valve assembly including:
a rotary valve having a plurality of fluid flow plenums defined therealong;
a plurality of windows formed along the inner housing, each window of the plurality of windows being in fluid communication with a corresponding one of the valve flow plenums;
an inner housing enclosing the valve, the inner housing being fixed with respect to the valve so as to rotate in correspondence with the valve, thereby maintaining fluid communication between each window and a respective one of the plenums;
an outer housing enclosing the inner housing and having at least two fluid flow apertures formed therealong, each of the fluid flow apertures being in fluid communication with a corresponding one of the regenerative chambers
the inner housing being rotatable with respect to the outer housing to bring an inner housing window into alignment with an outer housing fluid flow aperture, thereby bringing the inner housing window into fluid communication with the outer housing aperture and correspondingly enabling fluid communication between the plenum that is in fluid communication with the window, and the regenerative chamber that is in fluid communication with the outer housing flow aperture.

26. The oxidizer system of claim 25 wherein the valve is longitudinal, a portion of a first plenum and a portion of a second plenum are aligned longitudinally along the valve, a first inner housing window is in fluid communication with the portion of the first plenum, a second inner housing window is in fluid communication with the portion of the second plenum, and the inner housing is rotatable with respect to the outer housing to bring the first inner housing window into alignment with a first outer housing flow aperture and the second inner housing window into alignment with a second outer housing flow aperture, thereby enabling fluid communication between the first plenum and the first regenerative chamber and between the second plenum and the second regenerative chamber.

27. The oxidizer system of claim 26 wherein the first plenum conveys inflow gas to the first regenerative chamber, and the plenum channel receives outflow gas from the second regenerative chamber.

28. The oxidizer system of claim 26 wherein the oxidizer includes three regenerative chambers, the portion of the first plenum, the portion of the second plenum, and a portion of a third plenum are aligned longitudinally along the valve, a third inner housing window is in fluid communication with the portion of the third plenum, and the inner housing is rotatable with respect to the outer housing to bring the third inner housing window into alignment with a third outer housing flow aperture, thereby bringing the third inner housing window into fluid communication with the third outer housing aperture to enable fluid communication between the third plenum and the third regenerative chamber.

29. The oxidizer system of claim 28 wherein the first plenum conveys inflow gas to the first regenerative chamber, the second plenum receives outflow gas from the second regenerative chamber, and the third plenum conveys a purge gas to the third regenerative chamber.

30. The oxidizer system of claim 29 wherein the valve has a wall defining a fluid flow channel extending along the valve, at least one aperture formed in the wall to enable fluid communication between the channel and at least one of the fluid flow plenums, and a purge gas conduit in fluid communication with the valve flow channel, for supplying a purge gas to the valve flow channel.

31. The oxidizer system of claim 28 wherein the first plenum conveys one of an inflow gas flowing into the oxidizer system, an outflow gas flowing out of the oxidizer system, or a purge gas; and
the second plenum conveys another one of an inflow gas flowing into the oxidizer system, an outflow gas flowing out of the oxidizer system, or a purge gas.

32. The oxidizer system of claim 28 wherein the first plenum conveys one of an inflow gas flowing into the oxidizer system, an outflow gas flowing out of the oxidizer system, or a purge gas;
the second plenum conveys another one of an inflow gas flowing into the oxidizer system, an outflow gas flowing out of the oxidizer system, or a purge gas; and
the third channel conveys the remaining one of an inflow gas flowing into the oxidizer system, an outflow gas flowing out of the oxidizer system, or a purge gas.

33. The oxidizer system of claim 26 wherein the inner housing is rotatable with respect to the outer housing to bring a third inner housing window into alignment with the first outer housing flow aperture, and to bring a fourth inner housing window into alignment with the second outer housing flow aperture, the third inner housing window being in fluid communication with a channel different from the first channel, the fourth inner housing window being in fluid communication with a channel different from the second channel, thereby enabling fluid communication between the first regenerative chamber and the plenum in fluid communication with the third inner housing window, and enabling fluid communication between the second regenerative chamber and the plenum in fluid communication with the fourth inner housing window.
